(19) United States
(12) Patent Application Publication
(10) Pub. No.: US 2004/0223547 A1
(43) Pub. Date: Nov. 11, 2004

(54) System and method for MPEG-4 random access broadcast capability

(75) Inventor: Szepo Robert Hung, Irvine, CA (US)

Correspondence Address: Gerald W. Maliszewski, P.O. Box 270829, San Diego, CA, 92198-2829, US

(73) Assignee: Sharp Laboratories of America, Inc.

(21) Appl. No.: 10/434,302

(22) Filed: May 7, 2003

(51) Int. Cl. H04N 7/12

(52) U.S. Cl. 375/240.12; 375/240.26; 375/240.25

(57) ABSTRACT

A system and method are provided for broadcasting information compressed using the MPEG-4 standard. The method comprises: packetizing MPEG-4 compressed visual object sequence (VOS) data into an elementary stream (ES); for each VOS header in the ES, generating a first plurality of visual object (VO) and video object layer (VOL) headers; associating a second plurality of video object planes (VOPs) with each VO-VOL header; and, transmitting the ES. An Intra type VOPs (I-VOPs) is associated with a random access unit (RAU) and each VO-VOL header is associated with an I-VOP header. An alternate method comprises: accepting an initial program including IODs, ODs, and BIFSs; packetizing MPEG-4 compressed VOS data into an MPEP-2 ES; portioning the ES into RAUs including initial object descriptors (IODs), object descriptors (ODs), and scene description streams (binary format for scenes; BIFS); and, transmitting the ES.

### BACKGROUND OF THE INVENTION

1. Field of the Invention

This invention generally relates to Motion Pictures Expert Group (MPEG) video compression processes and, more particularly, to a system and method for generating a random access channel capability for information communicated in an MPEG-4 format.

2. Description of the Related Art

Channel capacity is a valuable broadcast asset, and a broadcaster can pack more programs into one channel bandwidth using a more efficient digital video compression technology. MPEG-2 defines a complete system infrastructure and video compression technology to serve this purpose. The more recent MPEG-4 technology was developed to provide better video/audio compression, with interactivity. However, the system and infrastructure for MPEG-4 and MEPG-2 are different. Although there is a placeholder in the MPEG-2 specification as to how MPEG-4 programs can be carried in MPEG2 system, there are problems related to this issue that have not been addressed. One of the problems is the random access capability (channel switch).

The current digital video broadcasting is based on the MPEG-2 technologies (MPEG-2 system+video/audio). The MPEG-2 (ISO/IEC 13818) was developed for the digital video system such as DVD and broadcasting, and it has become the standard for digital TV broadcasting industry. The MPEG-4 system and video/audio were mainly developed for the Internet streaming, for example, using the ISMA standard. The MPEG-4 (ISO/IEC 14496) technology can be efficiently used for the purpose of providing interactive multimedia presentation. It also defines a video/audio compression technology that is more efficient than the MPEG-2 video/audio compression technology. With an efficient video compression technique, less data need be sent over the Internet from the server side to the client side. This video transmission efficiency would be a desirable property for digital TV broadcast as well.

However, there are some problems to be overcome before MPEG-4 video compression technology can be used in the digital TV broadcasting environment with the conventional MPEG-2 infrastructure and equipment. The major difference between Internet streaming and broadcasting is the Internet's lack of a channel change (random access) capability. For the Internet streaming application, the session is set up before the video data is sent. Therefore, the receiving side has full knowledge of the format of the incoming video, and the video data comes in the expected way. On the other hand, in a digital broadcast using the transport stream (as defined in the MEPG-2 system specification), the receiving side cannot negotiate with the server as to the content to be transmitted. Therefore, a way must be developed for MPEG-4 programs to provide the channel change (random access) capability for users who tune to into a program at a random time.

There are two methods of carrying MPEG-4 programs in the MPEG2 system as defined in ISO/IEC13818-1. The first way is to treat the MPEG-4 video/audio elementary streams as a type of stream to be carried by MPEG-2 transport stream. This method assumes that the MPEG-4 program is just like a traditional video program, with only one rectangular video and audio. The MPEG-4 video is first packetized as Packetized Elementary Stream (PES) and then encapsulated into MPEG-2 transport stream. Each VOP (Video Object Plane) or access unit is encapsulated within on PES packet.

The other way to carry an MPEG-4 program in a MPEG-2 transport stream is carry both the video/audio and the MPEG-4 system information (Initial object descriptors, object descriptors, BIFS, IPMP, OCI, etc). This information is needed for MPEG-4 programs that have built-in interactivity.

Image data from one VOP may be used as a basis for predicting the image data of a block in another VOP. Coding begins with an Intra VOP (I-VOP), without prediction. The I-VOP data may be used to predict data of a second VOP, a P-VOP. Blocks of the second VOP are coded based on differences between the actual data and the predicted data from blocks of the I-VOP. Image data of another type of VOP may be predicted from two previously coded VOPs. The third VOP is a bi-directional VOP (B-VOP). The B-VOP typically is coded after the I-VOP and P-VOP are coded. However, the different types of VOPs may be coded in an order that is different than the order in which they are displayed.

When prediction is performed, image data is coded as motion vectors and residual texture information. Blocks may be thought to “move” from frame to frame (VOP to VOP). Thus, MPEG-4 codes motion vectors for each block. The motion vector predicts the image data of a current block by moving image data of blocks from previously coded VOPs to the current block. However, because such prediction is imprecise, the encoder also transmits residual texture data representing changes that must be made to the predicted image data to generate accurate image data.

MPEG-4 video defines the following bit stream structure: Visual Object Sequence (VOS)—Visual Object (VO)—Video Object Layer (VOL)—Group of Video Planes (GOV, optional)—Video Object Planes (VOP). The VOP is the “frame” in MPEG-2 terminology. In order for each frame (VOP) to be decoded, VOL headers are needed, as the VOL headers carry important information such as video width/height, time scale, quantization method, interfaced or frame-based, etc. Without VOL and VOP, a bit stream cannot be correctly decoded. For Internet streaming purposes, the existing MPEG4 encoding tools generate only one VOS-VO-VOL header, followed by a series of VOPs.

The Intra type VOP (I-VOP) can be thought of as a channel access point, because it does not depend on other types of VOPs to decode and display itself. The current MPEG-4 video is typically encoded with a very long GOV sequence (one I-VOP followed by a long series of other types of VOPs) to achieve high compression ratio. This is a problem for the broadcast environment. When a user switches a channel, the decoder doesn't have anything to show until the I-VOP has been received and decoded. In the interim, the TV screen will show a long interval of blank screen. The viewer may think the channel has no program when they change to this channel, and decide to change to other channel. Alternately, the viewer will find the relatively long periods of blank screen to be annoying.

It would be advantageous if the more efficient MPEG-4 coding process could be used in random access channel selection scenarios.

It would be advantageous if MEPG-4 video compression could be used in a digital TV broadcasting environment.

### SUMMARY OF THE INVENTION

This invention addresses the problem of randomly accessing a channel in an MPEG-4 data stream and offers a solution to realize the advantages of MPEG-4 coding in current MPEG-2 broadcasting equipment and systems. This invention permits broadcasters to take advantage of the newer and better MPEG-4 technology, with minimal modifications to the existing MPEG2 systems and equipment. The use of MPEG-4 compression technology, in turn, permits more TV programs to be transmitted and received within the same channel bandwidth. This invention proposes three techniques necessary to realize MPEG4 broadcasting on MPEG2 system and infrastructure.

Accordingly, a method is provided for broadcasting information compressed using the MPEG-4 standard. The method comprises: packetizing MPEG-4 compressed visual object sequence (VOS) data into an elementary stream (ES); for each VOS header in the ES, generating a first plurality of visual object (VO) and video object layer (VOL) headers; associating a second plurality of video object planes (VOPs) with each VO-VOL header; and, transmitting the ES.

Typically, a plurality of channels are packetized in the ES (or a plurality of ESs), and generating a first plurality of VO and VOL headers for each VOS header in the ES includes generating a first plurality of random access units for a channel. Alternately stated, a first plurality of Intra type VOPs (I-VOPs) are associated with a first plurality of random access units and each VO-VOL header is associated with an I-VOP header. Typically, each VO-VOL header is followed by a corresponding I-VOP header. In other aspects, an initial group of video object plane (GOV) is portioned into a first plurality of GOVs associated with the first plurality of I-VOPs.

An alternate method comprises: accepting an initial program including IODs, ODs, and BIFSs; packetizing MPEG-4 compressed VOS data into an MPEP-2 ES; portioning the ES into random access units (RAUs) including initial object descriptors (IODs), object descriptors (ODs), and scene description streams (binary format for scenes; BIFS); and, transmitting the ES.

In some aspects, portioning the ES into RAUs includes forming adjacent RAUs with overlapping BIFS elements. That is, forming a first RAU with a first BIFS last in a sequence of RAU elements; and, forming a second RAU, subseque it to the first RAU, with the first BIFS first in the sequence of RAU elements.

Additional details of the above-described methods and corresponding systems for broadcasting information using the MPEG-4 standard are provided below.

### BRIEF DESCRIPTION OF THE DRAWINGS

FIG. 1 is a schematic block diagram illustrating the present invention system for broadcasting information compressed using the MPEG-4 standard.

FIG. 2 is a diagram illustrating the framing structure associated with the system of FIG. 1.

FIG. 3 is a schematic block diagram of a variation of the present invention system for broadcasting information compressed using the MPEG-4 standard.

FIG. 4 is a diagram illustrating the framing structure of the system of FIG. 3.

FIG. 5 is a diagram illustrating another aspect of the framing structure associated with FIG. 3.

FIG. 6 is a diagram illustrating the concept of composing a MPEG-4 video bit stream for broadcast use.

FIG. 7 is a flowchart illustrating the present invention method for broadcasting information compressed using the MPEG-4 standard.

FIG. 8 is a flowchart illustrating a present invention method for receiving information compressed using the MPEG-4 standard.

FIG. 9 is a flowchart illustrating another present invention method for receiving information compressed using the MPEG-4 standard.

FIG. 10 is a flowchart illustrating another present invention method for broadcasting information compressed using the MPEG-4 standard.

### DETAILED DESCRIPTION OF THE PREFERRED EMBODIMENTS

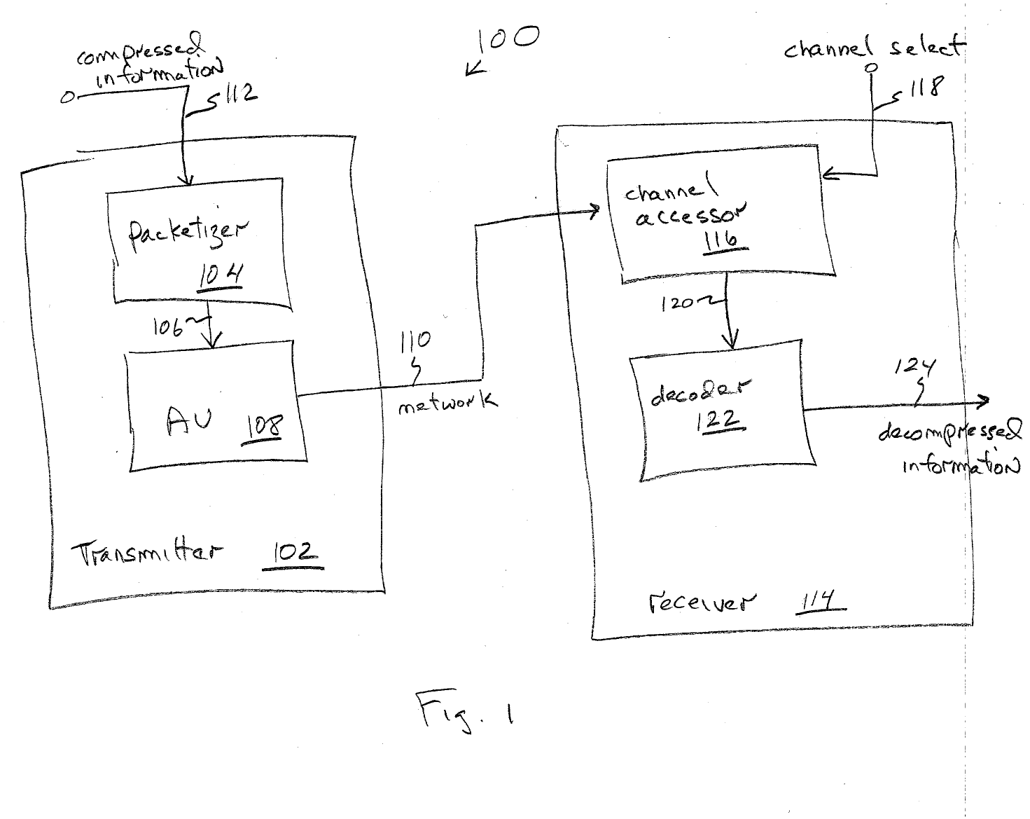

FIG. 1 is a schematic block diagram illustrating the present invention system for broadcasting information compressed using the MPEG-4 standard. The system 100 comprises a transmitter 102. The transmitter 102 includes a packetizer 104 with an output on line 106 to supply packetized MPEG-4 compressed visual object sequence (VOS) data in an elementary stream (ES). An access unit 108 (AU) has an input on line 106 to accept the ES and a network-connected output on line 110 to transmit the ES random access units (RAUs) with a first plurality of visual object (VO) and video object layer (VOL) headers for each VOS header in the ES. A second plurality of video object planes (VOPs) are associated with each VO-VOL header. Note that the system is not limited to any particular kind of network (line 110). The network can use a wireless, IP, digital wrapper, or SONET protocol, to name but a few examples.

Typically, the packetizer 104 packetizes a plurality of channels in the ES (on line 106) and the AU 108 generates a first plurality of random access units for each channel. As is conventional with MPEG-4 processes, the packetizer 104 typically supplies a plurality of ESs. Then, the AU 108 supplies a plurality of ESs with RAUs. Note that a single channel may be associated with a plurality of ESs.

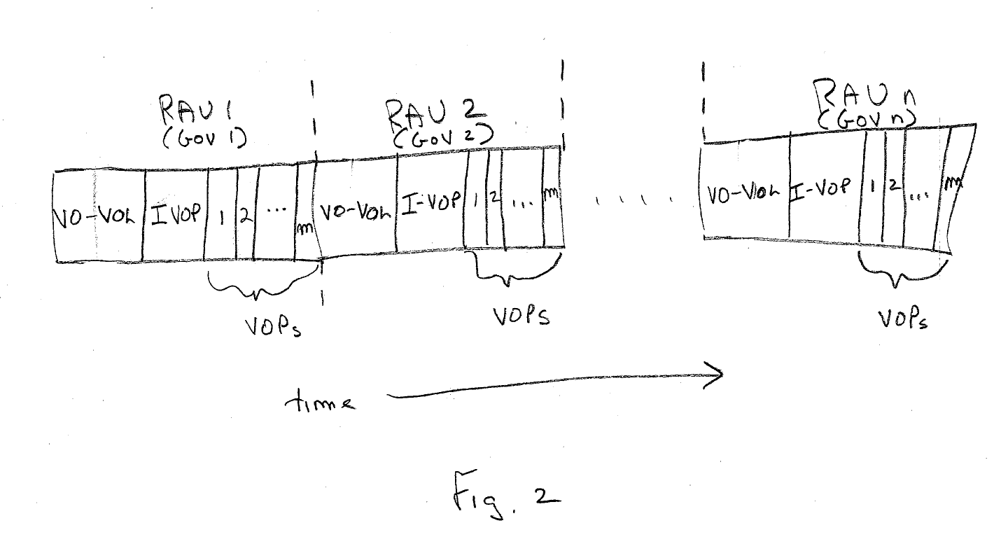

FIG. 2 is a diagram illustrating the framing structure associated with the system of FIG. 1. The AU generates a first plurality (n) of Intra type VOPs (I-VOPs) associated with a first plurality of random access channels and associates each VO-VOL header with an I-VOP header. The value of n is not limited to any particular value. As shown, the second plurality of VOPs is equal to m, where m is not related to any particular value.

Typically, each VO-VOL header is followed by a corresponding I-VOP header. The AU, therefore, must generate additional I-VOPs to create the RAUs. Considering both FIGS. 1 and 2, the AU 108 generates I-VOPs by converting VOPs in the ES on line 106, where the VOPs can either be a predictive VOP (P-VOP) or a bidirectional VOP (B-VOP), into I-VOPs.

In some aspects of the system 100, the packetizer 104 accepts MPEG-4 compressed VOS data on line 112 with an initial group of video object plane (GOV) including a third plurality of VOPs. Then, the AU 108 portions the GOV into a first plurality of C-OVs associated with the first plurality of I-VOPs, with each GOV including a second plurality of VOPs.

Some aspects of the system 100 further comprise a receiver 114. The receiver 114 includes a channel accessor 116 having a network-connected input on line 110 to receive the ES and a control port on line 118 to accept a channel selection signal. The channel accessor 116 differentiates the I-VOP headers in the ES and supplies a selected channel from the ES at an output on line 120, in response to the differentiated I-VOP headers. In some aspects, the channel accessor 116 recombines the first plurality of GOVs into the initial GOV (accepted on line 112).

A decoder 122 has an input on line 120 to accept the selected channel from the channel accessor 116 and an output on line 124 to supply the initial GOV decompressed using MPEG-4 algorithms.

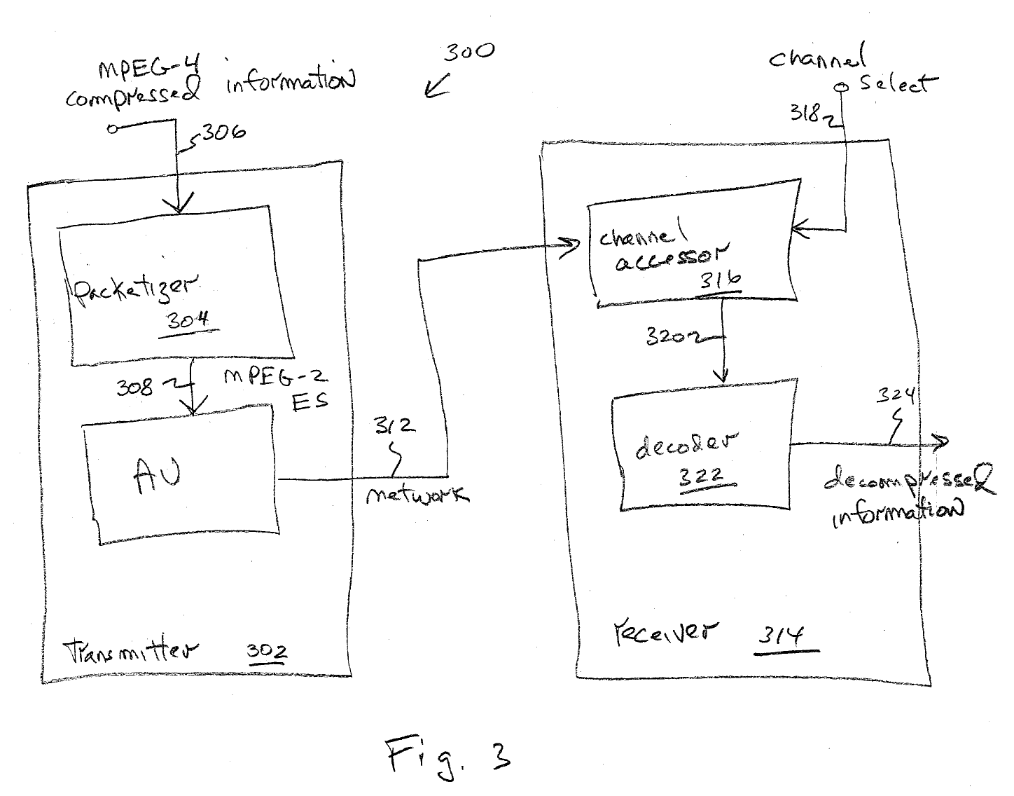

FIG. 3 is a schematic block diagram of a variation of the present invention system for broadcasting information compressed using the MPEG-4 standard. The system 300 comprises a transmitter 302. The transmitter 302 includes a packetizer 304 having an input on line 306 to accept MPEG-4 compressed visual object sequence (VOS) data and an output on line 308 to supply a packetized MPEP-2 elementary stream (ES). An access unit 310 (AU) has an input to accept the ES and a network-connected output on line 312 to supply the ES portioned into random access units (RAUs). Each RAU includes initial object descriptors (IODs), object descriptors (ODs), and scene description streams (binary format for scenes; BIFS).

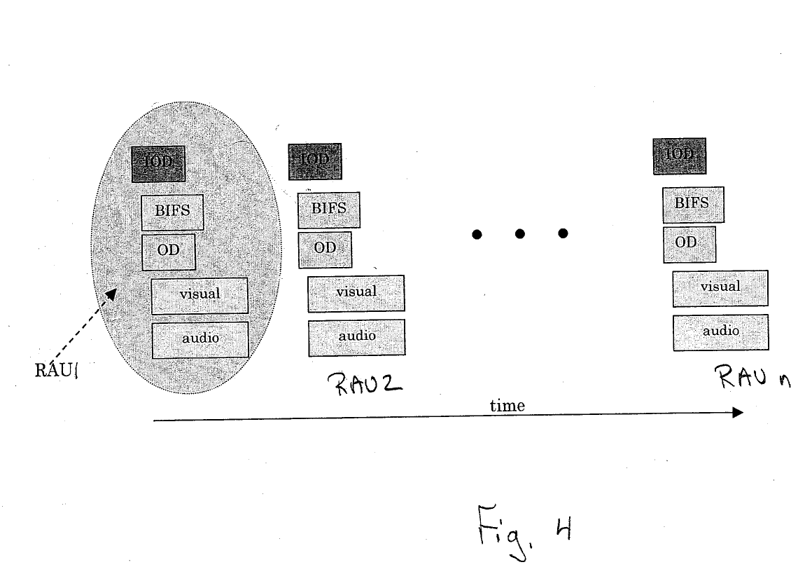

FIG. 4 is a diagram illustrating the framing structure of the system of FIG. 3. More specifically, the packetizer 302 accepts MPEG-4 compressed VOS data with an initial program including IODs, ODs, and BIFSs. Then, the AU 310 portions the initial program into a first plurality of RAUs. As shown, the initial program has been portioned into n RAUs, where n is not limited to any particular value. As is conventional, the packetizer 304 packetizes a plurality of channels in the ES. Then, the AU 310 generates a first plurality of RAUs for each channel. It would also be conventional for the packetizer 304 to supply packetized MPEG-4 compressed VOS data in a plurality of ES. Then, the AU 310 would supply a plurality of ESs with RAUs as described above.

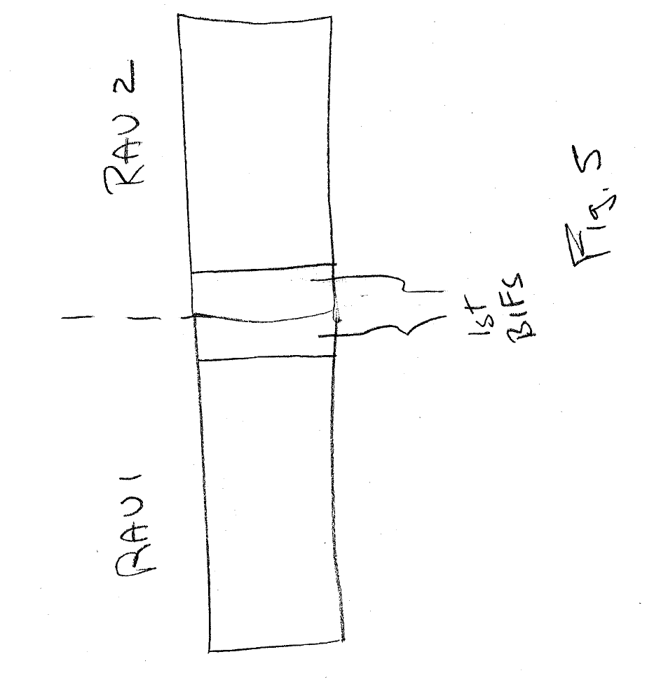

FIG. 5 is a diagram illustrating another aspect of the framing structure associated with FIG. 3. In some aspects of the system, the AU forms adjacent RAUs with overlapping BIFS elements. For example, the AU forms adjacent RAUs with overlapping BIFS elements by forming a first RAU (RAU 1) with a first BIFS last in a sequence of RAU elements. The AU forms a second RAU (RAU 2), subsequent to the first RAU, with the first BIFS first in the sequence of RAU elements.

Returning to FIG. 3, in some aspects the system 300 further comprises a receiver 314. The receiver 314 includes a channel accessor 316 having a network-connected input on line 312 to receive the ES and a control input on line 318 to accept a channel select signal. The channel accessor 316 has an output on line 320 to supply a selected channel in response to differentiating the RAUs in the ES.

In some aspects, the channel accessor 316 recombines the first plurality of RAUs into the initial program (accepted on line 306). A decoder 322 has an input on line 320 to accept the selected channel from the channel accessor 316 and an output on line 324 to supply the initial program decompressed using MPEG-4 algorithms.

### Functional Description

The present invention generates RAUs through the periodic insertion of VO and VOL headers in the video stream. The MPEG-4 video defines the following bit stream structure: Visual Object Sequence (VOS)—Visual Object (VO)—Video Object Layer (VOL)—Group of Video Planes (GOV, optional)—Video Object Planes (VOP). The VOP is the “frame” in MPEG2 terminology. In order for each frame (VOP) to be decoded, VOL headers are needed, as they carry information such as video width/height, time scale, quantization method, interfaced or frame-based, etc. Without VOL headers, the VOP bit stream cannot be correctly decoded. For Internet streaming purpose, the existing MPEG-4 encoding tools generate only one VOS-VO-VOL header and it is followed by a series of VOPs only. In order use MPEG-4 video compression in a digital broadcast environment, VO and VOL headers must be periodically inserted into the video bit stream. Therefore, no matter when a viewer tunes a channel, the receiver can always find the correct VO and VOL headers to decode the following VOPs.

Furthermore, I-VOPs can be used as a random access point because they are not dependent upon other types of VOPs to decode and display itself. The current MPEG-4 video is typically encoded with a very long GOV sequence (one I-VOP followed by a long series of other types of VOPs) to achieve high compression ratio. This is a problem for the broadcast environment. When users switch a channel, the decoder doesn't have anything to show until the I-VOP has been received and decoded. Thus, the TV screen shows a long interval of blank screen. The viewer may think the channel has no program when they change to this channel and decide to change to other channel.

To solve this problem, the MPEG-4 video bit stream is modified to create a short GOV structure for broadcast use. If the original MPEG-4 video bit stream has a long GOV structure, it has to be re-encoded into smaller GOVs. The GOV is the basic building element for the video stream. Each GOV starts with an I-VOP and is followed by other types of VOPs. The length of the GOV depends on the user's toleration of blank time on the TV screen. Therefore, re-encoding is required to convert a B-VOP or P-VOP into I-VOP, if the original MPEG-4 bit stream has a very long GOV structure. Then, each GOV should be preceded with a proper VO-VOL header, as mentioned above, so that the subsequent VOPs can be decoded. Preferably, the VO-VOL headers are inserted before the I-VOP.

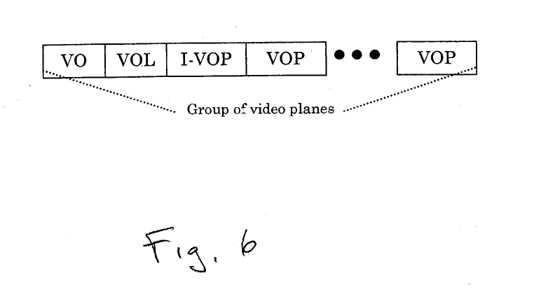

FIG. 6 is a diagram illustrating the concept of composing a MPEG-4 video bit stream for broadcast use. The GOV forms the basic building block for the MPEG-4 video stream. The other types of VOPs (B or P) follow an I-VOP in each GOV. Each GOV is preceded with proper VO and VOL headers. For a presentation that involves still images or 2-D/3-D graphics, the data such as still image, vertices coordinates and texture map should also be included in the GOV. The entire program is a repetition of such GOV structure. With such bit stream structure in place, the receiver can quickly receive all the necessary data to decode and display the visual content when it tunes to this channel.

For the case where MPEG-4 system information is carried in a MPEG-2 transport stream, the system information is reorganized to allow random access capability. The MPEG-4 specification defines that each program is identified by the Initial Object Descriptor (IOD), which points to a scene description stream (BIFS), and an Object Descriptor (OD) stream. The BIFS and OD refer to elementary streams (visual and audio). For the broadcast environment, the configuration information such as IOD, OD and BIFS must be sent and updated regularly. This information also needs to be synchronized with the associated visual and audio elementary streams. For broadcast use, the original IOD, OD and BIFS are parsed and partitioned as a sequence of very short presentations, programs, or RAUs. The starting point of the current program is the end point of the previous one. BIFS is the binary format of describing the interaction of objects on the display. Therefore, the BIFS presentation at the end of a previous short program, is the beginning of the current short program.

The present invention method partitions the original program into a sequence of short programs, which are called random accessible units (see FIG. 4). Each RAU can be independently decoded and displayed without the information contained in a prior RAU. The visual portion of the RAU is one GOV. When playing back all these RAUs continuously, the presentation is a smooth replication of the original program. This partition process is transparent to the viewers.

The granularity of the RAU is not a hard, defined number. It depends on the broadcasters' requirements and system capability, channel capacity, and a viewer's tolerance of a blank screen between channel switching. As an illustration of this invention, a GOV of 15 VOPs is presented as an example. With 30 frames per second display speed, the original MPEG-4 program is reorganized into a large number of short programs with 0.5 second of duration each. At the beginning of the 0.5-second RAU, new IOD, OD and BIFS are sent, replacing those in the previous RAU. The VO and VOL headers are inserted preceding the VOPs in a GOV, and the VOPs are encoded to have an I-VOP as the first VOP for this GOV. For a presentation that involves 2-D or 3-D graphics, and still images, during this presentation time interval, the vertices and the texture maps are also included in the RAU.

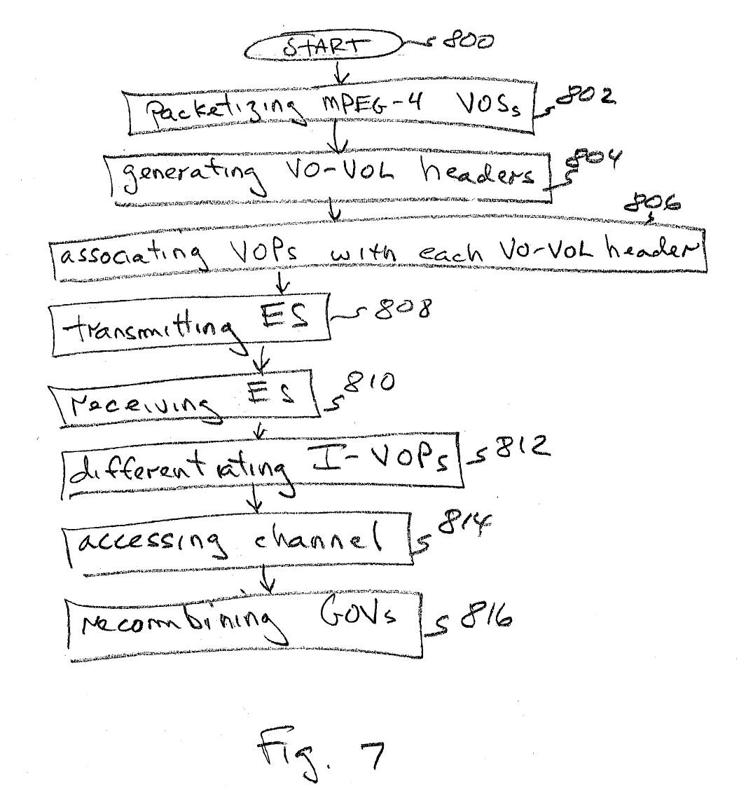

FIG. 7 is a flowchart illustrating the present invention method for broadcasting information compressed using the MPEG-4 standard. Although the method is depicted as a sequence of numbered steps for clarity, no order should be inferred from the numbering unless explicitly stated. It should be understood that some of these steps may be skipped, performed in parallel, or performed without the requirement of maintaining a strict order of sequence. The method starts at Step 800.

Step 802 packetizes MPEG-4 compressed visual object sequence (VOS) data into an elementary stream (ES). Typically, Step 802 forms a plurality of ESs. Step 804, for each VOS header in the ES, generates a first plurality of visual object (VO) and video object layer (VOL) headers. Step 806 associates a second plurality of video object planes (VOPs) with each VO-VOL header. Step 808 transmits the ES.

In some aspects of the method, packetizing MPEG-4 compressed VOS data into an ES in Step 802 includes packetizing a plurality of channels. Then, generating a first plurality of VO and VOL headers for each VOS header in the ES in Step 804 includes generating a first plurality of random access units for a channel. In some aspects, Step 804 includes generating a first plurality of Intra type VOPs (I-VOPs) associated with a first plurality of random access units. Then, associating a second plurality of VOPs with each VO-VOL header in Step 806 includes associating each VO-VOL header with an I-VOP header. Typically, Step 806 includes each VO-VOL header being followed by a corresponding I-VOP header.

In other aspects, generating a first plurality of I-VOPs associated with a first plurality of random access units for a channel in Step 804 includes converting VOPs such as either predictive VOPs (P-VOPs) or bi-directional VOPs (B-VOPs), into I-VOPS.

In some aspects the method comprises a step, Step 801 (not shown), prior to packetizing MPEG-4 compressed VOS data into an ES, of accepting an initial group of video object plane (GOV) including a third plurality of VOPs. Then, generating a first plurality of VO and VOL headers for each VOS header in the ES in Step 804 includes portioning the GOV into a first plurality of GOVs associated with the first plurality of I-VOPs, where each GOV includes a second plurality of VOPs.

In other aspects, Step 810 receives the ES. Step 812 differentiates the I-VOP headers in the ES. Step 814 accesses a channel in response to the differentiated I-VOP headers. Step 816 recombines the first plurality of GOVs into the initial GOV.

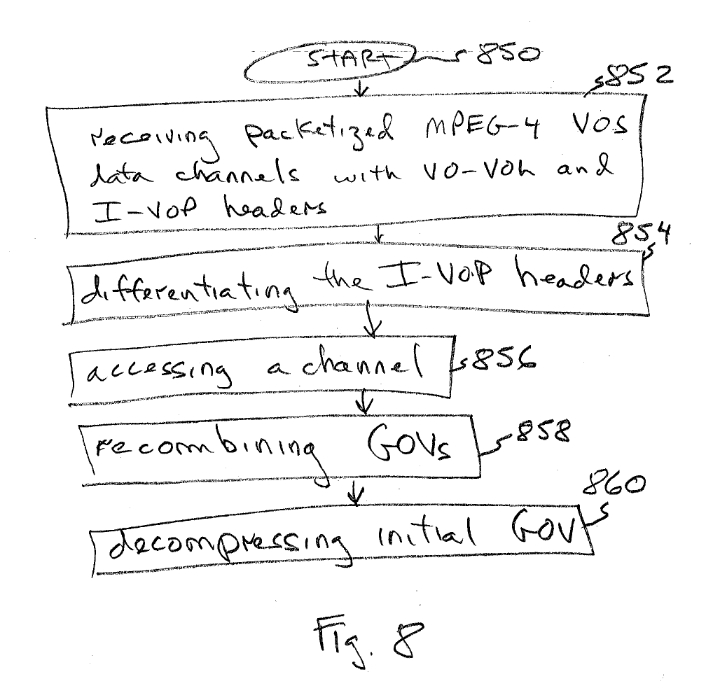

FIG. 8 is a flowchart illustrating a present invention method for receiving information compressed using the MPEG-4 standard. The method starts at Step 850. Step 852 receives packetizing MPEG-4 compressed visual object sequence (VOS) data channels in an elementary stream (ES) including a first plurality of visual object (VO), video object layer (VOL), and Intra type video object planes (I-VOPs) headers for each VOS header in the ES. Step 854 differentiates the I-VOP headers in the ES. Step 856 accesses a channel in response to the differentiated I-VOP headers. In some aspects, Step 858 recombines a first plurality of GOVs, associated with a first plurality of I-VOPs, into an initial GOV. Step 860 decompresses the initial GOV using MPEG-4 algorithms.

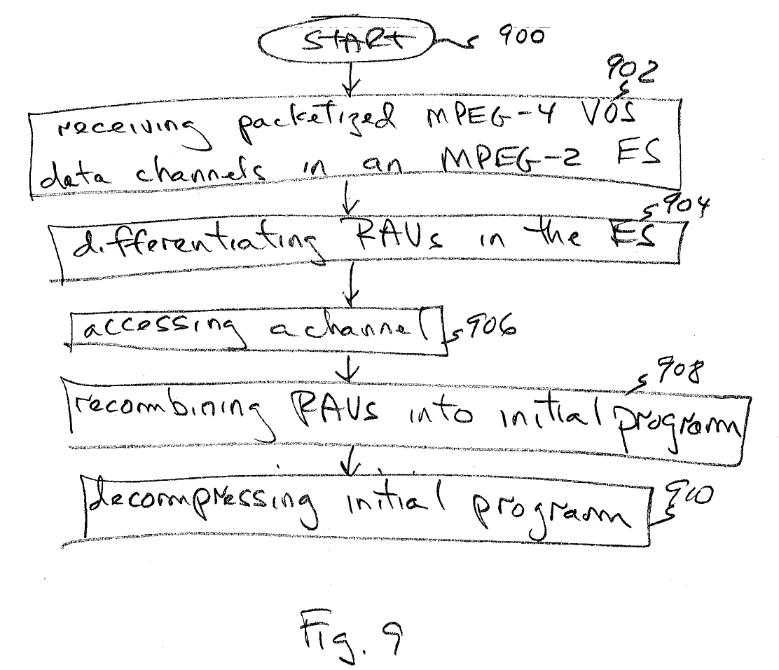

FIG. 9 is a flowchart illustrating another present invention method for receiving information compressed using the MPEG-4 standard. The method starts at Step 900. Step 902 receives packetizing MPEG-4 compressed visual object sequence (VOS) data channels in an MPEP-2 elementary stream (ES). Step 904 differentiates random access units (RAUs) in the ES including initial object descriptors (IODs), object descriptors (ODs), and scene description streams (binary format for scenes; BIFS). Step 906 accesses a channel in response to the differentiated RAUs. In some aspects, Step 908 recombines a first plurality of RAUs into an initial program. Step 910 decompresses the initial program using MPEG-4 algorithms.

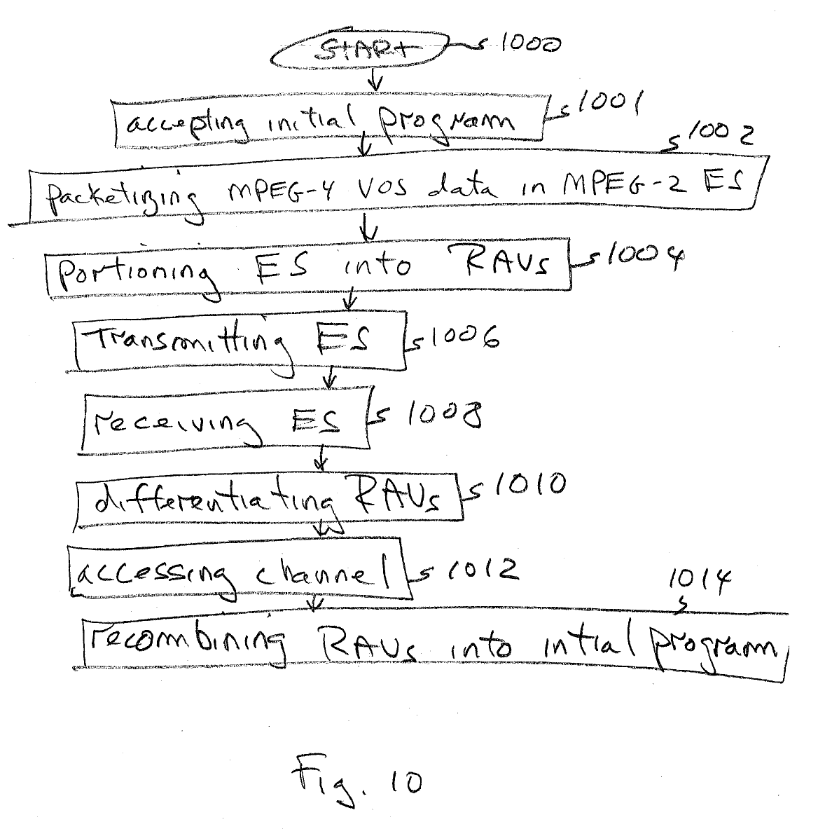

FIG. 10 is a flowchart illustrating another present invention method for broadcasting information compressed using the MPEG-4 standard. The method starts at Step 1000. Step 1002 packetizes MPEG-4 compressed VOS data into an MPEP-2 ES. As with conventional processes, Step 1002 typically packetizes MPEG-4 VOS data into an MPEP-2 ES with a plurality of channels. As is also conventional, a plurality of ESs may be formed. Step 1004 portions the ES into RAUs including IODs, ODs, and BIFS. Step 1006 transmits the ES.

In some aspects a further step, Step 1001, prior to packetizing MPEG-4 compressed VOS data into an MPEP-2 ES, accepts an initial program including IODs, ODs, and BIFSs. Then, portioning the ES into RAUs in Step 1004 includes portioning the initial program into a first plurality of RAUs.

In some aspects, portioning the ES into RAUs in Step 1004 includes forming adjacent RAUs with overlapping BIFS elements. For example, forming adjacent RAUs with overlapping BIFS elements may include: forming a first RAU with a first BIFS last in a sequence of RAU elements; and, forming a second RAU, subsequent to the first RAU, with the first BIFS first in the sequence of RAU elements.

In some aspects of the method, Step 1008 receives the ES. Step 1010 differentiates the RAUs in the ES. Step 1012 accesses a channel in response to the differentiated RAUs. Step 1014 recombines the first plurality of RAUs into the initial program.

Systems and methods have been presented for randomly accessing channels in MPEG-4 coded information. Although a few examples have used to illustrate the invention, the invention is not limited to merely these examples. This invention makes possible the digital broadcast MPEG4 coded information using the existing MPEG-2 digital broadcast system. This invention, for example, could be used in a set-top box that receives and decodes the MPEG-2 digital broadcast bit stream. With addition of a MPEG-4 decoder, the set-top box could decode the MPEG-4 programs carried on the MPEG-2 bit stream. Other variations and embodiments of the invention will occur to those skilled in the art.

We claim:

1. A method for broadcasting information compressed using the Moving Pictures Expert Group (MPEG)-4 standard, the method comprising:
packetizing MPEG-4 compressed visual object sequence (VOS) data into an elementary stream (ES);
for each VOS header in the ES, generating a first plurality of visual object (VO) and video object layer (VOL) headers;
associating a second plurality of video object planes (VOPs) with each VO-VOL header; and,
transmitting the ES.

2. The method of claim 1 wherein packetizing MPEG-4 compressed visual object sequence (VOS) data into an elementary stream (ES) includes packetizing a plurality of channels; and,
wherein generating a first plurality of VO and VOL headers for each VOS header in the ES includes generating a first plurality of random access units for a channel.

3. The method of claim 2 wherein packetizing MPEG-4 compressed VOS data into an ES includes forming a plurality of ESs.

4. The method of claim 3 wherein generating a first plurality of VO and VOL headers for each VOS header in the ES includes generating a first plurality of Intra type VOPs (I-VOPs) associated with a first plurality of random access units; and,
wherein associating a second plurality of VOPs with each VO-VOL header includes associating each VO-VOL header with an I-VOP header.

5. The method of claim 4 wherein associating each VO-VOL header with an I-VOP header includes each VO-VOL header being followed by a corresponding I-VOP header.

6. The method of claim 4 wherein generating a first plurality of I-VOPs associated with a first plurality of random access units for a channel includes converting VOPs selected from the group including predictive VOPs (P-VOPs) and bi-directional VOPs (B-VOPs) into I-VOPs.

7. The method of claim 6 further comprising:
prior to packetizing MPEG-4 compressed VOS data into an ES, accepting an initial group of video object plane (GOV) including a third plurality of VOPs; and,
wherein generating a first plurality of VO and VOL headers for each VOS header in the ES includes portioning the GOV into a first plurality of GOVs associated with the first plurality of I-VOPs, each GOV including a second plurality of VOPs.

8. The method of claim 4 further comprising:
receiving the ES;
differentiating the I-VOP headers in the ES; and,
accessing a channel in response to the differentiated I-VOP headers.

9. The method of claim 8 further comprising:
recombining the first plurality of GOVs into the initial GOV.

10. A method for broadcasting information compressed using the Moving Pictures Expert Group (MPEG)-4 standard, the method comprising:
packetizing MPEG-4 compressed visual object sequence (VOS) data into an MPEP-2 elementary stream (ES);
portioning the ES into random access units (RAUs) including initial object descriptors (IODs), object descriptors (ODs), and scene description streams (binary format for scenes; BIFS); and,
transmitting the ES.

11. The method of claim 10 further comprising:
prior to packetizing MPEG-4 compressed VOS data into an MPEP-2 ES, accepting an initial program including IODs, ODs, and BIFSs; and,
wherein portioning the ES into RAUs includes portioning the initial program into a first plurality of RAUs.

12. The method of claim 11 wherein packetizing MPEG-4 VOS data into an MPEP-2 ES includes packetizing a plurality of channels.

13. The method of claim 12 wherein portioning the ES into RAUs includes forming adjacent RAUs with overlapping BIFS elements.

14. The method of claim 13 wherein forming adjacent RAUs with overlapping BIFS elements includes:
forming a first RAU with a first BIFS last in a sequence of RAU elements; and,
forming a second RAU, subsequent to the first RAU, with the first BIFS first in the sequence of RAU elements.

15. The method of claim 10 wherein packetizing MPEG-4 compressed VOS data into an MPEP-2 ES includes forming a plurality of ESs.

16. The method of claim 14 further comprising:
receiving the ES;
differentiating the RAUs in the ES; and,
accessing a channel in response to the differentiated RAUs.

17. The method of claim 16 further comprising:
recombining the first plurality of RAUs into the initial program.

18. A method for receiving information compressed using the Moving Pictures Expert Group (MPEG)-4 standard, the method comprising:
receiving packetizing MPEG-4 compressed visual object sequence (VOS) data channels in an MPEP-2 elementary stream (ES);
differentiating random access units (RAUs) in the ES including initial object descriptors (IODs), object descriptors (ODs), and scene description streams (binary format for scenes; BIFS); and,
accessing a channel in response to the differentiated RAUs.

19. The method of claim 18 further comprising:
recombining a first plurality of RAUs into an initial program; and,
decompressing the initial program using MPEG-4 algorithms.

20. A method for receiving information compressed using the Moving Pictures Expert Group (MPEG)-4 standard, the method comprising:
receiving packetizing MPEG-4 compressed visual object sequence (VOS) data channels in an elementary stream (ES) including a first plurality of visual object (VO), video object layer (VOL), and Intra type video object planes (I-VOPs) headers for each VOS header in the ES;
differentiating the I-VOP headers in the ES; and,
accessing a channel in response to the differentiated I-VOP headers.

21. The method of claim 20 further comprising:
recombining a first plurality of GOVs, associated with a first plurality of I-VOPs, into an initial GOV; and,
decompressing the initial GOV using MPEG-4 algorithms.

22. A system for broadcasting information compressed using the Moving Pictures Expert Group (MPEG)-4 standard, the system comprising:
a transmitter including:
a packetizer having an output to supply packetized MPEG-4 compressed visual object sequence (VOS) data in an elementary stream (ES); and,
an access unit (AU) having an input to accept the ES and a network-connected output to transmit the ES random access units (RAUs) with a first plurality of visual object (VO) and video object layer (VOL) headers for each VOS header in the ES, and a second plurality of video object planes (VOPs) associated with each VO-VOL header.

23. The system of claim 22 wherein the packetizer packetizes a plurality of channels in the ES; and,
wherein the AU generates a first plurality of random access units for each channel.

24. The system of claim 23 wherein packetizer supplies a plurality of ESs; and,
wherein the AU supplies a plurality of ESs with RAUs.

25. The system of claim 24 wherein the AU generates a first plurality of Intra type VOPs (I-VOPs) associated with a first plurality of random access units and associates each VO-VOL header with an I-VOP header.

26. The system of claim 25 wherein the AU forms each VO-VOL header being followed by a corresponding I-VOP header.

27. The system of claim 26 wherein the AU generates I-VOPs by converting VOPs selected from the group including predictive VOPs (P-VOPs) and bidirectional VOPs (B-VOPs) into I-VOPs.

28. The system of claim 27 wherein the packetizer accepts MPEG-4 compressed VOS data with an initial group of video object plane (GOV) including a third plurality of VOPs; and,
wherein the AU portions the GOV into a first plurality of GOVs associated with the first plurality of I-VOPs, with each GOV including a second plurality of VOPs.

29. The system of claim 25 further comprising:
a receiver including:
a channel accessor having a network-connected input to receive the ES and a control port to accept a channel selection signal, the channel accessor differentiating the I-VOP headers in the ES and supplying a selected channel from the ES at an output, in response to the differentiated I-VOP headers.

30. The system of claim 29 wherein the channel accessor recombines the first plurality of GOVs into the initial GOV.

31. A system for receiving information compressed using the Moving Pictures Expert Group (MPEG)-4 standard, the system comprising:
a receiver including:
a channel accessor having a network-connected input to receive packetizing MPEG-4 compressed visual object sequence (VOS) data channels in an elementary stream (ES) including a first plurality of visual object (VO), video object layer (VOL), and Intra type video object planes (I-VOPs) headers for each VOS header in the ES, the channel accessor having a control input to accept channel select signals, the channel accessor differentiating the I-VOP headers in the ES and supplying a selected channel at an output in response to the differentiating I-VOP headers.

32. The system of claim 31 wherein the channel accessor recombines a first plurality of GOVs, associated with a first plurality of I-VOPs, into an initial GOV; and,
the system further comprising:
a decoder having an input to accept the selected channel from the channel accessor and an output to supply the initial GOV decompressed using MPEG-4 algorithms.

33. A system for broadcasting information compressed using the Moving Pictures Expert Group (MPEG)-4 standard, the system comprising:
a transmitter including:
a packetizer having an input to accept MPEG-4 compressed visual object sequence (VOS) data and an output to supply a packetized MPEP-2 elementary stream (ES); and,
an access unit (AU) having an input to accept the ES and a network-connected output to supply the ES portioned into random access units (RAUs) including initial object descriptors (IODs), object descriptors (ODs), and scene description streams (binary format for scenes; BIFS).

34. The system of claim 33 wherein the packetizer accepts MPEG-4 compressed VOS data with an initial program including IODs, ODs, and BIFSs; and,
wherein the AU portions the initial program into a first plurality of RAUs.

35. The system of claim 34 wherein the packetizer packetizes a plurality of channels in the ES; and,
wherein the AU generates a first plurality of RAUs for each channel.

36. The system of claim 35 wherein the AU forms adjacent RAUs with overlapping BIFS elements.

37. The system of claim 36 wherein the AU forms adjacent RAUs with overlapping BIFS elements by:
forming a first RAU with a first BIFS last in a sequence of RAU elements; and,
forming a second RAU, subsequent to the first RAU, with the first BIFS first in the sequence of RAU elements.

38. The system of claim 33 wherein the packetizer supplies packetized MPEG-4 compressed VOS data in a plurality of ESs; and,
wherein the AU supplies a plurality of ESs with RAUs.

39. The system of claim 37 further comprising:
a receiver including:
a channel accessor having a network-connected input to receive the ES, a control input to accept a channel select signal, and an output to supply a selected channel in response to differentiating the RAUs in the ES.

40. The system of claim 39 wherein the channel accessor recombines the first plurality of RAUs into the initial program.

41. A system for receiving information compressed using the Moving Pictures Expert Group (MPEG)-4 standard, the system comprising:
a receiver including:
a channel accessor having a network-connected input to receive MPEG-4 compressed visual object sequence (VOS) data channels packetized in an MPEP-2 elementary stream (ES), a control input to accept a channel select signal, the channel accessor differentiating random access units (RAUs) in the ES including initial object descriptors (IODs), object descriptors (ODs), and scene description streams (binary format for scenes; BIFS), and supplying a selected channel at an output in response to differentiating the RAUs in the ES.

42. The system of claim 41 wherein the channel accessor recombines a first plurality of RAUs into an initial program; and,
the system further comprising:
a decoder having an input to accept the selected channel from the channel accessor and an output to supply the initial program decompressed using MPEG-4 algorithms.
